(19) United States
(12) Patent Application Publication
(10) Pub. No.: US 2012/0296968 A1
(43) Pub. Date: Nov. 22, 2012

(54) System and Method for Group Communications in 3GPP Machine-to-Machine Networks

(75) Inventors: Fuchun Joseph Lin, Morris Plains, NJ (US); Ming-Yee Lai, Short Hills, NJ (US); Subir Das, Belle Mead, NJ (US); Jyh-Cheng Chen, Hsinchu (TW)

(73) Assignee: TELCORDIA TECHNOLOGIES, INC., Piscataway, NJ (US)

(21) Appl. No.: 13/365,847

(22) Filed: Feb. 3, 2012

Related U.S. Application Data
(60) Provisional application No. 61/439,157, filed on Feb. 3, 2011.

(51) Int. Cl. G06F 15/16

(52) U.S. Cl. 709/204

(57) ABSTRACT

An inventive system and method for group communication among devices in M2M networks comprises associating one or more of the devices with a gateway having a unique identifier, initiating registration of the devices at an M2M network using the unique identifier of the gateway, providing from the network a temporary identifier to the gateway and associating, in the network, the temporary identifier with the gateway, attaching the devices to the network using the temporary identifier, and communicating information between the network and the device through the gateway. In one aspect, the devices can be classified into sub-groups and each sub-group has a sub-group head that can be attached to the gateway so that the devices can communicate with the network through the sub-group head instead of the gateway. Each sub-group can be associated with a unique temporary identifier, in addition to the temporary identifier associated with the gateway.

### CROSS REFERENCE TO RELATED APPLICATIONS

The present invention claims the benefit of U.S. provisional patent application 61/439,157 filed Feb. 3, 2011, the entire contents and disclosure of which are incorporated herein by reference as if fully set forth herein.

### FIELD OF THE INVENTION

This invention relates generally to machine-to-machine (M2M) communications and wireless cellular communications (2G, 3G or 4G) and in particular to managing a large number of devices in M2M communications.

### BACKGROUND OF THE INVENTION

Machine-to-machine (M2M) communication, like traditional wireless cellular communication, has access and core network infrastructure, which need to be reliable, scalable, available, secure and manageable. M2M communication also has its unique requirements, such as supporting multiple types of M2M applications, automatic connect/disconnect, and management of large numbers of devices. In recent years, the first generation M2M communication has been provided by network operators and Mobile Virtual Network Operators (MVNOs) for their enterprise customers using local area wireless technologies (e.g., ZIGBEE, WID) and/or narrow-band wide area wireless technologies in the access network. The first generation M2M communication uses the existing 2G/2.5G (e.g., GPRS) core network with no or little changes since the data traffic (mainly control signals) produced by the current limited number of standalone M2M applications is still relatively small compared to traditional communication.

The next generation M2M communication will utilize the 3G/4G broadband wireless networks (e.g., LTE, WiMAX) based on an all-Internet Protocol (IP) network, that is, using IP in the access network and the core network. The next generation M2M communication imposes potential challenges in the core network, such as supporting multiple concurrent M2M services with rich functionality, traffic/QoS control for M2M in conjunction with traditional communication and/or managing a large number of devices in the presence of IPv4 address exhaust.

### SUMMARY OF THE INVENTION

The inventive techniques presented herein can perform functions that fulfill several of the known requirements for M2M communications. In 3GPP, M2M communication is also referred to as Machine-Type Communication (MTC). For example, the identified problems with several addressing schemes are related to address space limitations which can be solved by the novel solution herein described. Such limits concern IMSI, MSISDN and IPv4 in particular. In addition, extending usage of identifiers in MTC context can be achieved, for example to allow simpler charging mechanisms for MTC Devices belonging to the same group of devices. The network shall provide a mechanism to reduce peaks in the data and signaling traffic resulting from very large numbers of MTC Devices (almost) simultaneously attempting data and/or signaling interactions.

A novel method for group communication among devices in M2M networks comprises associating one or more of the devices with a gateway having a unique identifier, initiating registration of the devices at an M2M network using the unique identifier of the gateway, providing from the network a temporary identifier to the gateway and associating, in the network, the temporary identifier with the gateway, attaching the devices to the network using the temporary identifier, and communicating information between the network and the device through the gateway. In one aspect, the devices can be classified into sub-groups and each sub-group has a sub-group head that can be attached to the gateway so that the devices can communicate with the network through the sub-group head instead of the gateway. Each sub-group can be associated with a unique temporary identifier, in addition to the temporary identifier associated with the gateway.

A novel system for group communication among devices in M2M networks comprises a processor and a module operable to associate one or more of the devices with a gateway having a unique identifier, to initiate registration of the devices at an M2M network using the unique identifier of the gateway, to provide from the network a temporary identifier to the gateway and to associate, in the network, the temporary identifier with the gateway, to attach the devices to the network using the temporary identifier, and to communicate information between the network and the device through the gateway. In one aspect, the devices can be classified into sub-groups and each sub-group has a sub-group head that can be attached to the gateway so that the devices can communicate with the network through the sub-group head instead of the gateway. Each sub-group can be associated with a unique temporary identifier, in addition to the temporary identifier associated with the gateway.

In one aspect, the sub-group head serves as a relay station for communicating information between the network and the device. In one aspect, location updating is performed for the one or more devices when the one or more devices move to a new routing area whether the one or more devices are under control of a same network mobility control element or under different network mobility control elements. In one aspect, paging of the devices is performed using one of common characteristics of the devices in a sub-group, and the temporary identifier of the sub-group head with the mapping tables in the core network and on the gateway.

A computer readable storage medium storing a program of instructions executable by a machine to perform one or more methods described herein also may be provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 shows architecture defined by ETSI for M2M Communication.

FIG. 2 shows exemplary architecture for the present invention.

FIG. 3 shows an embodiment having one group and no sub-groups.

FIG. 4 shows an embodiment having N sub-groups.

FIG. 5 shows performing registration in an embodiment of the invention.

FIG. 6 is a flow diagram for performing registration.

FIG. 7 shows performing attachment in an embodiment of the invention.

FIG. 8 shows performing intra-SGSN routing area updating in an embodiment of the invention.

FIG. 9 shows performing inter-SGSN routing area updating in an embodiment of the invention.

FIG. 10 shows performing paging in an embodiment of the invention

### DETAILED DESCRIPTION

A novel group communication mechanism is presented, including an exemplary embodiment over the 3GPP-based core network and M2M area network. In the inventive system and method, some M2M devices are grouped together to focus on reducing the usage of IMSI and performing signaling such as charging (billing), registration, route area update, and paging.

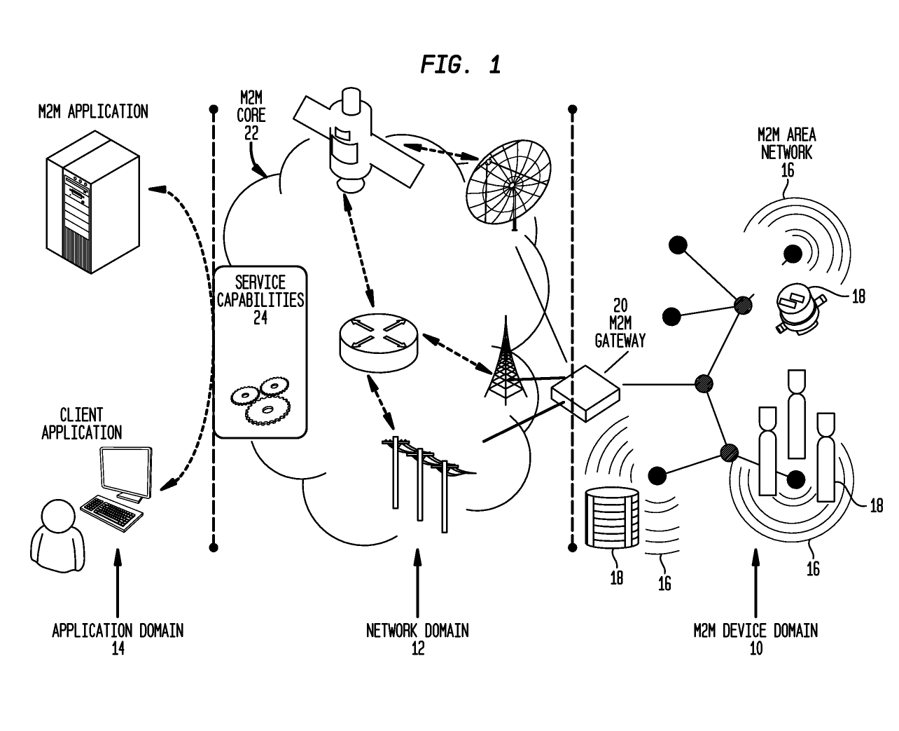

Many standards bodies are defining standards for M2M communication. FIG. 1, for example, shows the architecture defined by the ETSI (European Telecommunications Standards Institute); this architecture includes the M2M Device Domain 10, the Network Domain 12 and the Application Domain 14.

The M2M Device Domain 10 comprises several M2M Area Networks 16 which may be based on Zigbee, Bluetooth, WLAN, etc. The M2M devices 18 in the M2M Device Domain 10 may connect to the M2M Gateway (M2M GW) 20 directly (not shown) or by one of the M2M Area Networks 16, each of which connects to the M2M GW 20. The M2M GW 20 is the interface between individual M2M Area Networks 16 and the M2M Core 22.

The Network Domain 12 can be based on a satellite network, fiber network, LTE, WiMAX, etc., and the Network Domain 12 can include M2M Core 22. Network Domain is essentially a “Core Network” which provides a wide-area backhaul for M2M networks.

The Application Domain 14 provides client or end-user applications. Service capabilities 24 provide services between the Network Domain 12 and the Application Domain 14. These service capabilities 24 provide an API (application program interface) for applications so that they do not need to know the details of the networking architecture and technologies.

Wireless cellular (such as 2G, 3G or 4G, etc.) networks distinguish explicitly between equipment (such as mobile devices) and users, e.g., subscribers, and the networks deal with them separately. Addresses and identifiers are needed for the management of subscriber mobility and for addressing the network elements. Accordingly, in addition to telephone numbers and subscriber and equipment identifiers, temporary subscriber identifiers can be created. These addresses and identifiers in the context of cellular networks can be defined as follows.

Mobile Station Unique Identifier (MStaId). The MStaId uniquely identifies a mobile station internationally. Examples are IMEI (International Mobile Station Equipment Identity) in 3GPP and Electronic Serial Number (ESN)/Mobile Equipment Identifier (MEID) in 3GPP2.

Mobile Subscriber Unique Identifier (MSubId). The MSubId uniquely identifies a mobile subscriber internationally. Each registered user is uniquely identified by this MSubId. It can be stored in a removable smart card, such as SIM (Subscriber Identity Module), R-UIM (Removable User Identity Module designed solely for cdma2000), CDMA SIM (CSIM), etc. In 3GPP and 3GPP2 MSubId corresponds to International Mobile Subscriber Identity (IMSI). Alternatively, in 3GPP2, MSubId can be provisioned as part of the mobile station such as Mobile Identification Number (MIN). A mobile station can only be operated if a SIM, R-UIM or CSIM with a valid MSubId is inserted into the mobile station, or if an MSubId is provisioned as part of the mobile station.

Mobile Subscriber Dialing Number (MSubNum). MSubNum is the telephone number of a mobile station. It is assigned to the subscriber. Note that a mobile station may have more than one MSubNum. MSubNum is a unique dialing number associated with the subscriber and the mobile station used by the subscriber. MSubNum corresponds to Mobile Subscriber ISDN number (MSISDN) in both 3GPP and 3GPP2.

Temporary Subscriber Unique Identifier (TmpSubId). A cellular network can assign a TmpSubId to the subscriber which has only local significance in the visiting domain handled by the cellular network. This TmpSubId does not need to be passed back to the subscriber's home domain. Together with the current location area, TmpSubId allows a subscriber to be identified uniquely. TmpSubId is a temporarily and dynamically assigned identifier that uniquely identifies a mobile subscriber service. TmpSubId corresponds to Mobile Subscriber Identity (TMSI) in 3GPP and in 3GPP2 when IMSI is used. When IMSI is not used in 3GPP2, there is no TmpSubId.

The present invention advantageously enables reducing usage of MSubId, utilizing the re-usable TmpSubId and performing group signaling for activities such as charging (billing), registration, routing area update and paging.

All M2M devices 18 within the M2M Area Network are referred to as a “group”. The M2M Area Network 16 may be stationary or moving. When moving, all of M2M devices in the same group are assumed to move altogether. M2M GW owns a valid MSubId which is shared by all M2M devices in the group. Within the same group, the M2M devices are further grouped into several sub-groups. The notion of relays that has been introduced in 3GPP Long Term Evolution-Advanced (LTE-A) can be readily applied to M2M networks. Each sub-group head can be a relay between the M2M GW and the M2M devices. Each sub-group head owns its own TmpSubId, which is shared among all M2M devices in the sub-group.

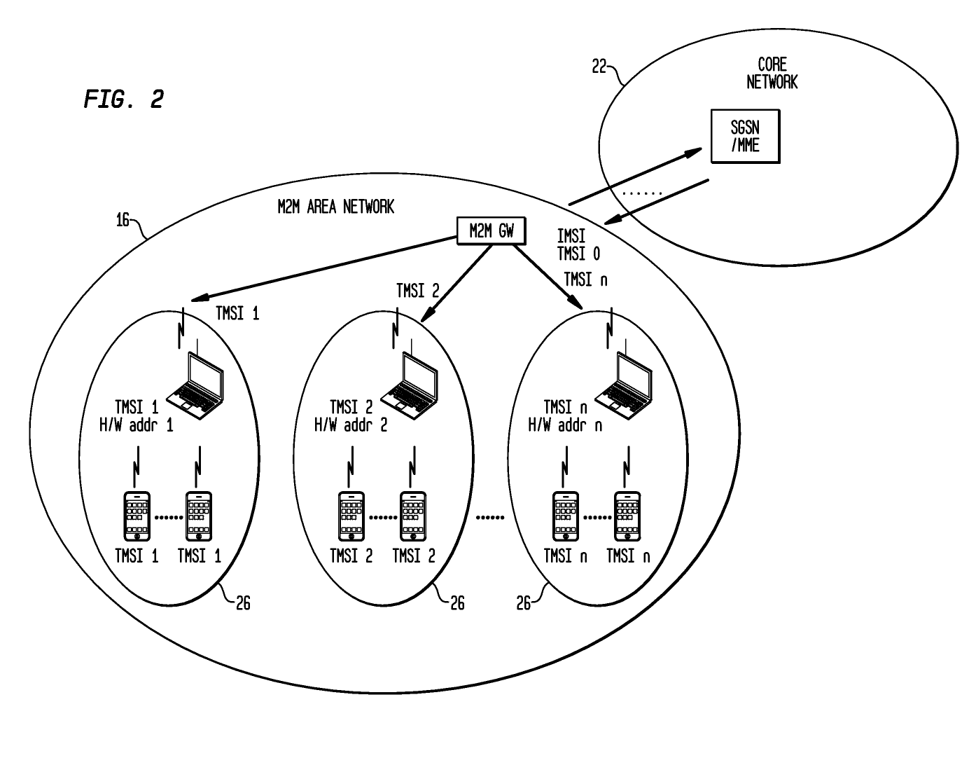

FIG. 2 shows exemplary architecture of the present invention. In FIG. 2, the 3GPP LTE core network is used as an example. In this case, M2M Core is the 3GPP core network entity, e.g., Serving GPRS Support Node (SGSN) and/or Mobility Management Entity (MME); this entity maintains a mapping between the MSubId (IMSI in 3GPP) and the TmpSubId (TMSIs in 3GPP). FIG. 2 shows only one group, e.g., the entire M2M Area Network serves as a single group, but multiple groups can exist.

FIG. 2 shows multiple sub-groups 26. The number of sub-groups is denoted as “n” in the exemplary M2M Area Network shown in FIG. 2. As mentioned above, the M2M devices within the same sub-group share the same TmpSubId (TMSI in 3GPP). There are different ways to group and/or sub-group M2M devices. For example, grouping can be done based on location proximity or administration domain or other criteria. Any criteria can be used for grouping and/or sub-grouping in the present invention.

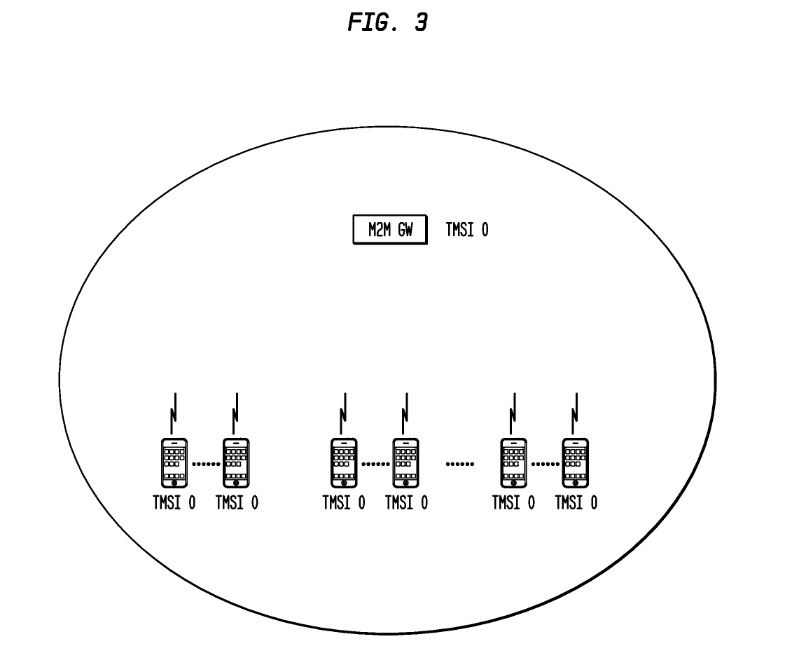

FIG. 3 shows the case when there is one group and no sub-group, e.g., n=0, with TMSI 0. In this case, all M2M devices share the same TmpSubId (in 3GPP, TMSI) with the M2M GW. Hence the M2M GW has an IMSI of TMSI 0 and each device in the group also has an identifier, e.g., IMSI, of TMSI 0.

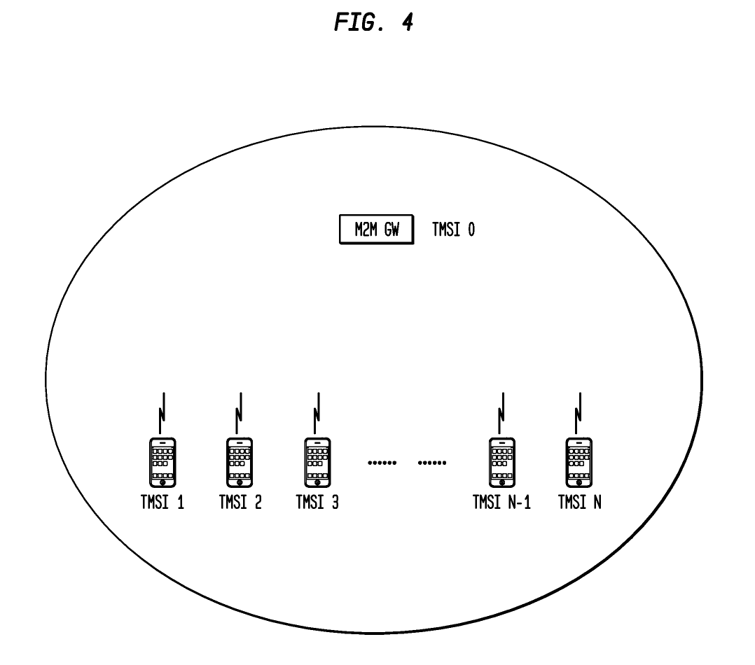

In FIG. 4, the total number of M2M devices in the group, excluding the M2M GW, is denoted as “N”. FIG. 4 shows the case when there are N sub-groups, i.e., n=N. In the example in FIG. 4, each M2M device is a sub-group by itself and each device has its own distinct TmpSubId (in 3GPP, with TMSI 1, TMSI 2, . . . , TMSI N−1, TMSI N). Note that, in some cases, there can be multiple sub-groups and one or more sub-groups can contain more than one device.

The inventive group communication mechanism performs the key procedures such as registration, attachment, location update and paging as follows.

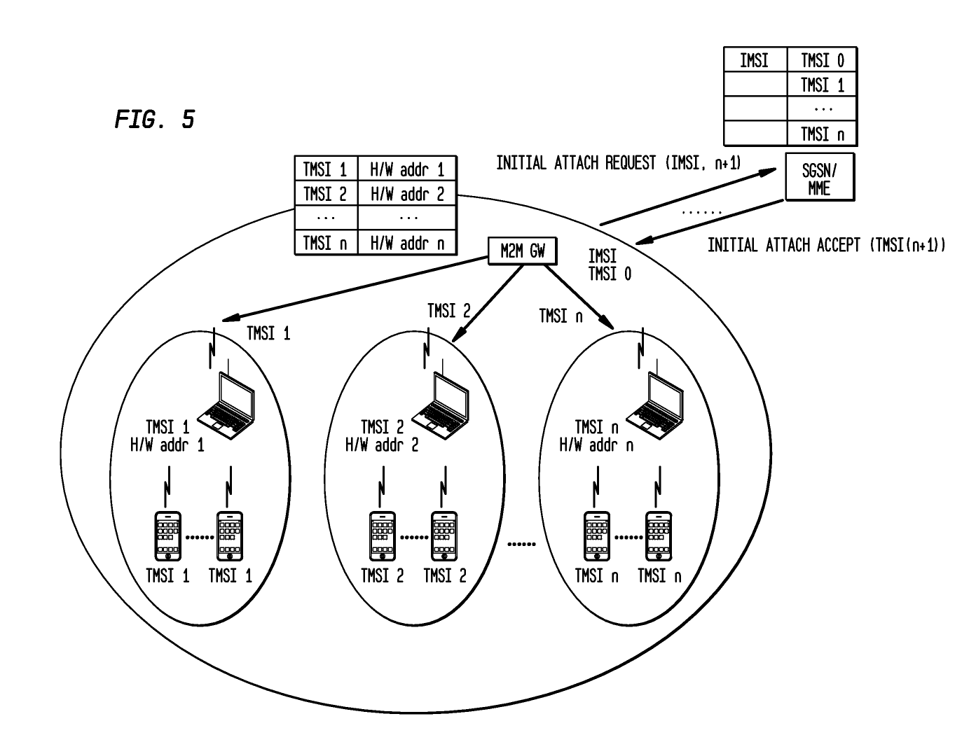

FIG. 5 shows performing registration with the novel mechanism. Again, the 3GPP LTE core network is used as the example. In FIG. 5, the M2M devices of the same group are connected to an M2M GW that owns a valid. IMSI (or MSubId in general case) issued by the cellular operator. This IMSI is shared by all M2M devices in the same group. All M2M devices perform registration signaling through the M2M GW. Because signaling is done for each device in the group through the gateway, the signaling traffic is reduced. In addition, as shown in FIG. 5, within the group, M2M devices can be further grouped into n sub-groups.

A device needs to register with the core network by using its MSubId before the device can access the core network. Accordingly the device begins registration with the core network and the core network assigns a TmpSubId to the device as a temporal ID. The core network then identifies the device by the TmpSubId. In FIG. 5, the M2M GW will send the Initial Attach Request on behalf of all devices in the group by using the M2M GW's MSubId. Depending on the number of sub-groups, e.g., n, the core network will create n+1 distinct TmpSubIds and send them back to the M2M GW by using Initial Attach Accept. The core network maintains the mapping between MSubId and TmpSubIds. After receiving the n+1 TmpSubIds, the M2M GW keeps the first TmpSubId for itself and sends the other n TmpSubIds to the n sub-group heads, where each sub-group receives a distinct TmpSubId.

The M2M GW identifies the sub-group heads by their hardware addresses. The M2M GW maintains the mapping between each TmpSubId and an associated sub-group head's hardware address. In wireless cellular networks, the hardware address is MStaId (or IMEI in 3GPP and ESN/MEID in 3GPP2). Each sub-group head further distributes the TmpSubId to its members. The distribution of the TmpSubIds to the sub-group heads is done by using the radio used in the M2M Area Network such as Zigbee, Bluetooth, or WLAN etc. The sub-group head also serves as a relay station for uplink and downlink communications with its sub-group members. The sub-group members, e.g., devices, are identified by their hardware addresses.

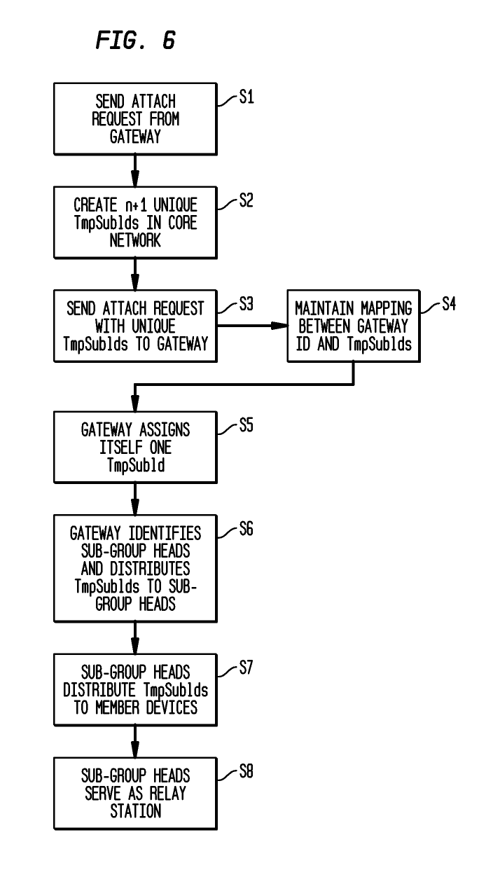

FIG. 6 is a flow diagram of the initial registration process to obtain acknowledgement of the existence of the devices, in accordance with the inventive system and method. Initially, a device needs to register with the core network. In step S1, the M2M GW sends an attach request on behalf of all of the devices in the group by using the M2M GW's MSubID. In step S2, the core network creates n+1 unique TmpSubIds, one for each sub-group requested by M2M GW. In step S3, the core network sends the attach accept with n+1 unique TmpSubIds to M2M GW. In step S4, the core network establishes and maintains the mapping between MSubId and TmpSubIds. In step S5, M2M GW assigns itself one TmpSubId. In step S6, M2M GW identifies the sub-group heads by their hardware addresses and assigns and maintains a mapping between each sub-group head hardware address and a TmpSubId assigned to the sub-group as a temporal ID. In step S7, each sub-group head distributes its TmpSubId to each device in the sub-group using the hardware address of each device. In step S8, each sub-group head serves as a relay station for communication with its sub-group members.

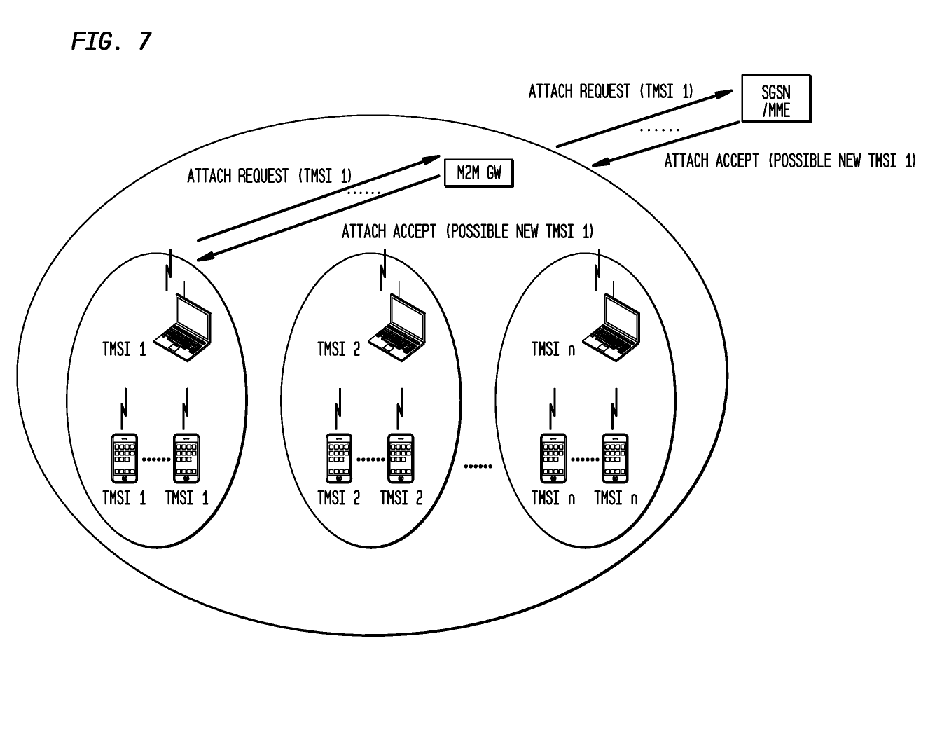

After registration, the core network knows the existence of the device. The device still needs to perform network attachment before it can access the core network. FIG. 7 illustrates how to perform 3GPP attachment as an example. As shown in FIG. 7, the sub-group head performs the attachment on behalf of all members in the sub-group. Thus, the signaling traffic is reduced.

The sub-group head performs the attachment on behalf of all members in the sub-group by sending Attach Request that contains its TMSI, e.g. TMSI 1 in FIG. 7, to the M2M Gateway. The M2M Gateway forwards the request to the network. The network will respond with Attach Accept to acknowledge the success of attachment. Note that the network may choose to assign a new TMSI, e.g. new TMSI 1, in FIG. 7 at this attachment process and send it back to the sub-group head via the M2M Gateway. All the devices in the sub-group will then share the new TMSI.

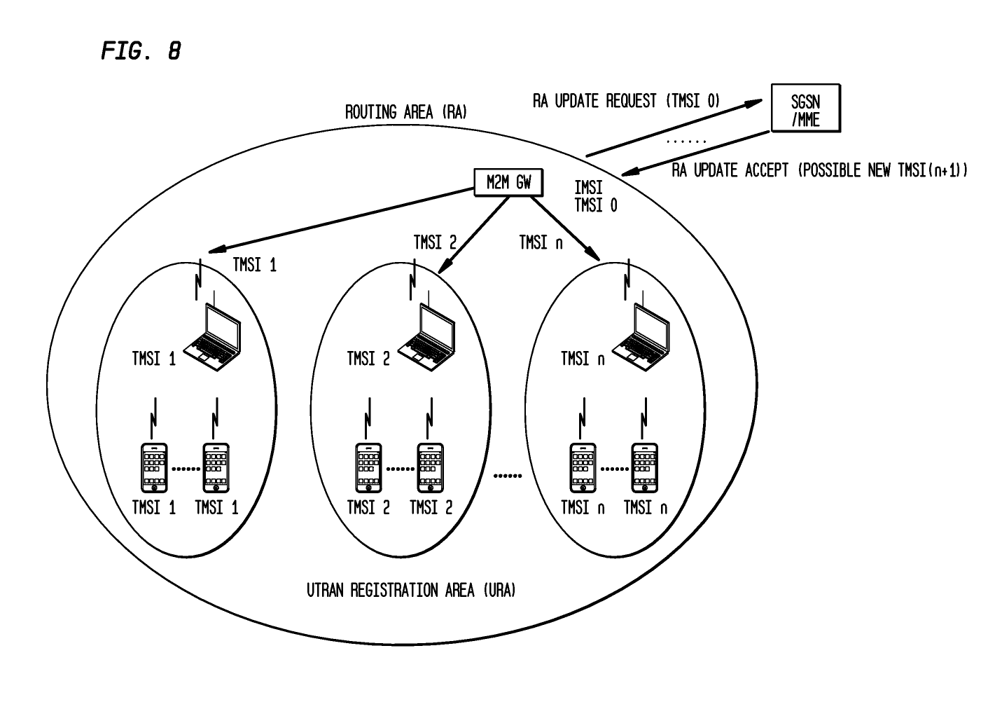

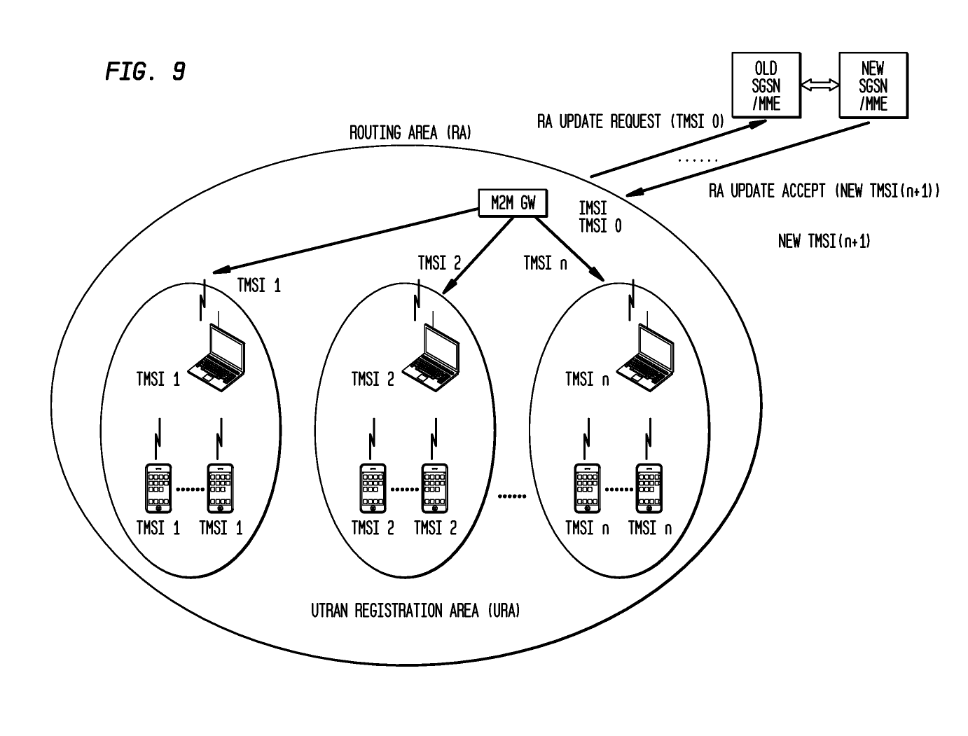

As mentioned above, a group may be stationary or moving. In accordance with the inventive system and method, location updating, such as Intra-SGSN/Inter-SGSN routing area update, can be performed if a group moves to a new routing area. FIG. 8 and FIG. 9 depict performing intra-SGSN and inter-SGSN routing area update, respectively, using 3GPP cellular networks as an example. After moving to a new location, the group may be required to perform intra-SGSN or inter-SGSN routing area update with new TMSIs. As shown in these figures, the M2M GW performs the routing area update on behalf of all M2M devices in the group. Therefore, it can reduce both signaling traffic and handoff latency significantly.

The procedure for intra-SGSN routing area update is as follows. When the M2M devices move as a group from one Routing Area (RA) to another but still under the same SGSN, the group of M2M devices have to do RA update by sending an RA Update Request that contains the TMSI of M2M GW, i.e. TMSI 0 in FIG. 8, to the network. Note that the network may choose to assign new TMSIs for the group, e.g. new TMSI(n+1) in FIG. 8, during this RA update process and send the new TMSIs back to the M2M Gateway. Consequently, the network may also update its mapping between IMSI and TMSIs.

The procedure for inter-SGSN routing area update is as follows. When the M2M devices move as a group from one Routing Area (RA) to another that is under a different SGSN, the M2M devices also have to do RA update by sending an RA Update Request that contains the TMSI of M2M GW, i.e. TMSI 0 in FIG. 9, to the network. Note that the network may choose to assign new TMSIs for the group, e.g. new TMSI(n+1) in FIG. 9, during this RA update process and send these new TMSIs back to the M2M Gateway. Consequently, the network may also update its mapping between IMSI and TMSIs.

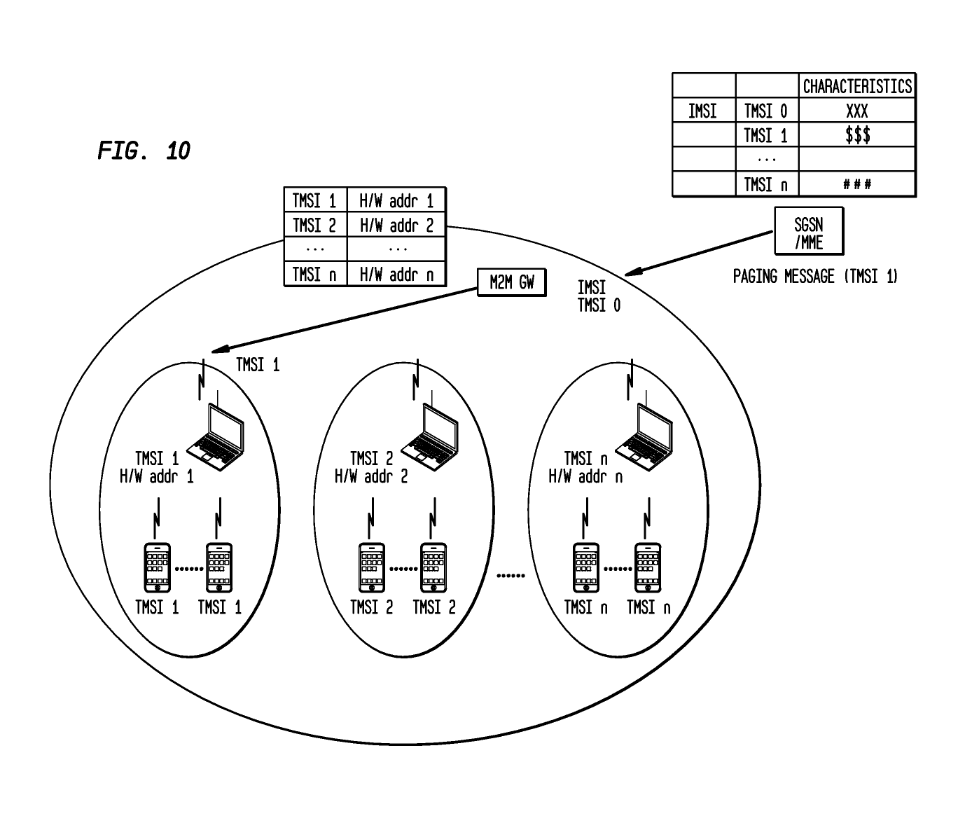

FIG. 10 shows how grouping paging is done using 3GPP networks. First, a paging message is issued to locate a device in idle mode using its TMSI. Because TMSI is shared by the M2M devices in the same sub-group, a paging message issued by the M2M Core, e.g., SGSN/MME, can reach multiple devices. If the grouping is done based on the characteristics of the devices, the characteristics of the sub-groups can also be stored in the table in SGSN/MME. Thus the core network can page devices with a certain characteristic. One example of characteristic is type of devices. For example, all smart meters can be placed in a sub-group and all vending machines can be placed in another sub-group. Thus, a paging message can be issued to page all smart meters or vending machines by paging the smart meter sub-group or the vending machine sub-group.

By sharing the same MSubId, the inventive system and method can advantageously reduce the number of MSubIds in the core network. Because all M2M devices in the same group share the MSubId of the M2M GW, only one MSubId is required for each M2M GW and the usage of MSubId can be reduced significantly.

The inventive system and method beneficially enables group charging or billing. Again because all M2M devices share the MSubId of the M2M GW, the devices all charge to the same MSubId. Thus, advantageously, grouping charging, an important requirement in M2M, can be achieved easily. In addition, SIM or CSIM containing a MSubId does not need to be installed in all M2M devices. Depending on the application, the number of M2M devices may be huge. In the novel mechanism, only one (C)SIM containing the MSubId of the M2M GW needs to be installed. This can reduce the operational overhead significantly.

Also, security concerns about stolen devices are reduced. The M2M devices may be distributed anywhere. They may be stolen or destroyed. Because the M2M devices do not have (C)SIM with MSubId installed, the security concern about the loss of (C)SIM is reduced, although a stolen device still needs to be managed properly, e.g., taken out of period sending cycle, removed from inventory, etc. The inventive system and method allows anonymity of the devices within the same sub-group. By sharing the same TmpSubId, anonymity of the devices within the same sub-group is permitted because the core network does not know which particular device performs attach and/or is paged, etc.

The inventive system and method supports M2M devices without MSubId. M2M devices without MSubId still can attach to a M2M core network. Also, the amount of signaling traffic is significantly reduced with the novel mechanism, because registration, attachment, location update, and paging can be done for a group of devices, not for each individual device.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc. The system also may be implemented on a virtual computer system, colloquially known as a cloud.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server, and network of servers (cloud). A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims

What is claimed is:

1. A method for group communication among devices in M2M networks, comprising steps of:
associating one or more of the devices with a gateway having a unique identifier;
initiating registration of the devices at an M2M network using the unique identifier of the gateway;
providing from the network a temporary identifier to the gateway and associating, in the network, the temporary identifier with the gateway;
attaching the devices to the network using the temporary identifier; and
communicating information between the network and the device through the gateway.

2. A method for group communication among devices in M2M networks, comprising steps of:
associating one or more of the devices with a gateway having a unique identifier;
initiating registration of the devices at an M2M network using the unique identifier of the gateway;
classifying each of the devices into one of a plurality of sub-groups, each sub-group having a sub-group head;
providing from the network one or more additional temporary identifiers and associating, in the network, one unique additional temporary identifier with the gateway and another unique additional temporary identifier with each sub-group head;
attaching each sub-group of the devices to the network using the additional temporary identifier associated with the sub-group head of the each sub-group; and
communicating information between the network and the device through the sub-group head via the gateway.

3. The method according to claim 2, wherein the sub-group head serves as a relay station for the communicating information step.

4. The method according to claim 2, further comprising steps of:
performing location updating for the one or more devices when the one or more devices move to a new routing area whether the one or more devices are under control of a same network mobility control element or under different network mobility control elements.

5. The method according to claim 2, further comprising steps of:
performing paging of the devices using one of common characteristics of the devices in a sub-group, and the temporary identifier of the sub-group head with mapping tables in the core network and on the gateway.

6. A computer readable storage medium storing a program of instructions executable by a machine to perform a method for group communication among devices in M2M networks, comprising:
associating one or more of the devices with a gateway having a unique identifier;
initiating registration of the devices at an M2M network using the unique identifier of the gateway;
providing from the network a temporary identifier to the gateway and associating, in the network, the temporary identifier with the gateway;
attaching the devices to the network using the temporary identifier; and
communicating information between the network and the device through the gateway.

7. A computer readable storage medium storing a program of instructions executable by a machine to perform a method for group communication among devices in M2M networks, comprising:
associating one or more of the devices with a gateway having a unique identifier;
initiating registration of the devices at an M2M network using the unique identifier of the gateway;
classifying each of the devices into one of a plurality of sub-groups, each sub-group having a sub-group head;
providing from the network one or more additional temporary identifiers and associating, in the network, one unique additional temporary identifier with the gateway and another unique additional temporary identifier with each sub-group head;
attaching each sub-group of the devices to the network using the additional temporary identifier associated with the sub-group head of the each sub-group; and
communicating information between the network and the device through the sub-group bead via the gateway.

8. The program according to claim 7, wherein the sub-group head serves as a relay station for the communicating information step.

9. The program according to claim 7, further comprising:
performing location updating for the one or more devices when the one or more devices move to a new routing area whether the one or more devices are under control of a same network mobility control element or under different network mobility control elements.

10. The program according to claim 7, further comprising:
performing paging of the devices using one of common characteristics of the devices in a sub-group, and the temporary identifier of the sub-group head with the mapping tables in the core network and on the gateway.

11. A system for group communication among devices in M2M networks, comprising:
a processor; and
a module operable to associate one or more of the devices with a gateway having a unique identifier, initiate registration of the devices at an M2M network using the unique identifier of the gateway, provide from the network a temporary identifier to the gateway and associating, in the network, the temporary identifier with the gateway, attach the devices to the network using the temporary identifier and communicate info nation between the network and the device through the gateway.

12. A system for group communication among devices in M2M networks, comprising:
a processor; and
a module operable to associate one or more of the devices with a gateway having a unique identifier, initiate registration of the devices at an M2M network using the unique identifier of the gateway, classify each of the devices into one of a plurality of sub-groups, each sub-group having a sub-group head, provide from the network one or more additional temporary identifiers and associating, in the network, one unique additional temporary identifier with the gateway and another unique additional temporary identifier with each sub-group head, attach each sub-group of the devices to the network using the additional temporary identifier associated with the sub-group head of the each sub-group and communicate information between the network and the device through the sub-group head via the gateway.

13. The system according to claim 12, wherein the sub-group head serves as a relay station for the communicating information step.

14. The system according to claim 12, the module further operable to perform location updating for the one or more devices when the one or more devices move to a new routing area whether the one or more devices are under control of a same network mobility control element or under different network mobility control elements.

15. The system according to claim 12, the module further operable to perform paging of the devices using one of common characteristics of the devices in a sub-group, and the temporary identifier of the sub-group head with the mapping tables in the core network and on the gateway.
